(19) United States
(12) Patent Application Publication
(10) Pub. No.: US 2026/0115891 A1
(43) Pub. Date: Apr. 30, 2026

(54) Eccentric Reducer Calculator Device

(71) Applicant: James Bouman, Nixon, TX (US)

(72) Inventor: James Bouman, Nixon, TX (US)

(21) Appl. No.: 19/329,690

(22) Filed: Sep. 16, 2025

Related U.S. Application Data
(60) Provisional application No. 63/713,120, filed on Oct. 29, 2024.

(51) Int. Cl. B25H 7/00

(52) U.S. Cl. CPC B25H 7/005

(57) ABSTRACT

An eccentric reducer calculator device is provided. The device is comprised of a planar sheet body having a plurality of concentric circle markings of progressively increasing diameter, corresponding to standard and non-standard pipe outer diameters. Extending from the central axis are horizontal centerline markings that reach opposite edges of the body, optionally labeled with numerical indicators, and in some embodiments vertical centerline markings that are orthogonally aligned for complete alignment referencing. The device functions by placing the relevant piping component in alignment with the concentric circle markings and centerlines, thereby enabling direct marking of the correct centerline for cutting, welding, or installation operations.

### CROSS-REFERENCE TO RELATED APPLICATION

The present application claims priority to, and the benefit of, U.S. Provisional Application No. 63/713,120, which was filed on Oct. 29, 2024, and is incorporated herein by reference in its entirety.

### FIELD OF THE INVENTION

The present invention relates generally to the field of pipe fitting. More specifically, the present invention relates to a device that allows a user to easily and quickly identify and mark the centerline of a pipe fitting of various sizes. Accordingly, the present disclosure makes specific reference thereto. Nonetheless, it is to be appreciated that aspects of the present invention are also equally applicable to other like applications, devices, and methods of manufacture.

### BACKGROUND

Eccentric reducers are essential components in piping systems where there is a need to transition between pipes of different diameters without creating air or fluid pockets. They are commonly used in industrial, commercial, and specialized piping networks that handle liquids, gases, or steam. A critical aspect of installing eccentric reducers is calculating and aligning the centerline so that connected piping sections fit correctly within the designed layout. Misalignment of the centerline can lead to fabrication errors, requiring adjustments or rework that disrupt the installation schedule. These errors can result in wasted materials, increased labor costs, and extended downtime for systems that cannot be commissioned until proper alignment is achieved. In large-scale industrial projects, such inefficiencies can have significant financial consequences and disrupt coordinated workflows between multiple trades. Traditional alignment methods often require manual calculations, visual estimation, or the use of makeshift templates, each of which introduces the possibility of human error. Furthermore, conditions in field environments such as poor lighting, uneven work surfaces, or limited space can further complicate alignment efforts.

Therefore, there exists a long-felt need in the art for an eccentric reducer calculator device that enables precise determination of the centerline of an eccentric reducer during installation. There also exists a long-felt need in the art for an eccentric reducer calculator device that minimizes calculation errors and reduces the need for rework. Moreover, there exists a long-felt need in the art for an eccentric reducer calculator device that increases installation efficiency and accuracy in both fabrication and field environments.

The subject matter disclosed and claimed herein, in one embodiment thereof, comprises an eccentric reducer calculator device. The device is comprised of a planar sheet body having a plurality of concentric circle markings of progressively increasing diameter, corresponding to standard and non-standard pipe outer diameters. Extending from the central axis are horizontal centerline markings that reach opposite edges of the body, optionally labeled with numerical indicators, and in some embodiments vertical centerline markings that are orthogonally aligned for complete alignment referencing. The device functions by placing the relevant piping component in alignment with the concentric circle markings and centerlines, thereby enabling direct marking of the correct centerline for cutting, welding, or installation operations.

In this manner, the eccentric reducer calculator device of the present invention accomplishes all the foregoing objectives and provides a dedicated, dimensionally accurate device for determining the centerline of eccentric reducers without the need for manual calculation or repeated adjustments. The concentric circle markings in conjunction with horizontal and vertical centerline references enable precise alignment even under challenging field conditions, thereby reducing the incidence of misalignment and fabrication errors. By enabling accurate centerline identification on the first attempt, the device eliminates guesswork, reduces labor time, and minimizes the need for costly rework, thus improving overall efficiency and quality in piping installation and fabrication processes.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an eccentric reducer calculator device. The device provides a precise, portable, and user-friendly tool for determining the centerline of piping components, particularly eccentric reducers used in pipefitting, welding, and fabrication. The device enables accurate alignment and marking of pipe sections, reducing misalignment risk during installation and allowing rapid, calculation-free positioning. The device is especially suited for industrial, commercial, and field use, where accuracy, speed, and repeatability improve efficiency, reduce rework, and save time.

The device is comprised of a planar sheet body with a length and width selected to suit different applications, available in standard or custom dimensions. The planar sheet body may have a rectangular, square, or polygonal shape. Some embodiments of the planar sheet body feature a weather-resistant coating to protect against moisture, UV exposure, and chemicals, optionally combined with a chemical-resistant finish for protection from solvents, oils, and cutting fluids.

A plurality of concentric circle markings is centrally located on the planar sheet body, with diameters corresponding to standard and non-standard pipe outer diameters. A set of horizontal centerline markings extends from the central axis of the concentric circles to the edges of the planar sheet body, serving as alignment references for eccentric reducers and other cylindrical workpieces. In some variations, the horizontal centerline markings include numerical labels indicating distance from center or circle diameter. Vertical centerline markings may also be included perpendicular to the horizontal centerline markings, to form an orthogonal alignment system.

The device functions as an eccentric reducer calculator, enabling precise determination of the exact centerline of an eccentric reducer. The combination of concentric circles and orthogonal centerline markings allows instant reference for the next pipe centerline, eliminating guesswork and reducing rework in fabrication.

The invention also comprises a method of use including the following steps. First, providing the planar sheet body with concentric circle markings, horizontal centerline markings, and vertical centerline markings. Next, a user can place the planar sheet body on a work surface using the non-slip bottom surface or fasteners to prevent movement. Then, a user can align the piping component with the appropriate concentric circle marking. Using the horizontal and vertical centerline markings to establish the exact centerline. Finally, marking the centerline onto the piping component to guide cutting, welding, or installation operations.

Accordingly, the eccentric reducer calculator device of the present invention is particularly advantageous as it provides a dedicated, dimensionally accurate device for determining the centerline of eccentric reducers without the need for manual calculation or repeated adjustments. The concentric circle markings in conjunction with horizontal and vertical centerline references enable precise alignment even under challenging field conditions, thereby reducing the incidence of misalignment and fabrication errors. By enabling accurate centerline identification on the first attempt, the device eliminates guesswork, reduces labor time, and minimizes the need for costly rework, thus improving overall efficiency and quality in piping installation and fabrication processes while overcoming the limitations of existing methods known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a top view of one potential embodiment of an eccentric reducer calculator device of the present invention in accordance with the disclosed architecture; and

FIG. 2 illustrates a flowchart of a method of using one potential embodiment of an eccentric reducer calculator device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an eccentric reducer calculator device that enables precise determination of the centerline of an eccentric reducer during installation. There also exists a long-felt need in the art for an eccentric reducer calculator device that minimizes calculation errors and reduces the need for rework. Moreover, there exists a long-felt need in the art for an eccentric reducer calculator device that increases installation efficiency and accuracy in both fabrication and field environments.

The present invention, in one exemplary embodiment, is comprised of an eccentric reducer calculator device. The device serves as a precise, portable, and user-friendly tool for identifying the centerline of piping components, particularly eccentric reducers in pipefitting, welding, and fabrication. Using the device, accurate alignment and marking of pipe sections is achieved, thus reducing the risk of misalignment during installation and enabling rapid, calculation-free positioning. The device is well-suited for industrial, commercial, and field applications where accuracy, speed, and repeatability enhance efficiency, reduce rework, and save time.

The device is comprised of a planar sheet body. Certain embodiments feature a weather-resistant coating for protection against moisture, UV exposure, and chemicals, optionally combined with a chemical-resistant finish to withstand solvents, oils, and cutting fluids.

A centrally positioned set of concentric circle markings is provided on the planar sheet body, with diameters corresponding to both standard and non-standard pipe outer diameters. Horizontal centerline markings extend from the central axis of the concentric circles to the sheet edges, serving as alignment guides for eccentric reducers and other cylindrical components. In some embodiments, the horizontal centerline markings are numerically labeled to indicate distance from center or circle diameter. Vertical centerline markings may also be provided perpendicular to the horizontal centerline markings, forming an orthogonal alignment reference system.

The device operates as an eccentric reducer calculator, allowing precise determination of the exact centerline of an eccentric reducer. The combination of concentric circles with orthogonal centerline markings enables immediate reference for the next pipe centerline, eliminating guesswork and reducing fabrication rework.

The invention also comprises a method of use. First, the method involves providing the planar sheet body with concentric circle markings, horizontal centerline markings, and vertical centerline markings. Next, the planar sheet body is placed on a work surface using a non-slip underside or fasteners to secure the position. Then, the piping component is aligned with the selected concentric circle marking. Next, a user uses the horizontal and vertical centerline markings to determine the exact centerline. Finally, a user can mark the determined centerline on the piping component to guide cutting, welding, or installation procedures.

As a result, the device offers a dedicated and dimensionally accurate means for determining the centerline of eccentric reducers without manual calculation or repeated adjustments. The integration of concentric circle markings with horizontal and vertical centerline references further provides precise alignment in challenging field conditions, reducing misalignment and fabrication errors. Accurate first-attempt centerline identification eliminates guesswork, shortens labor time, and minimizes costly rework, thereby enhancing efficiency and quality in piping installation and fabrication while addressing limitations of prior methods.

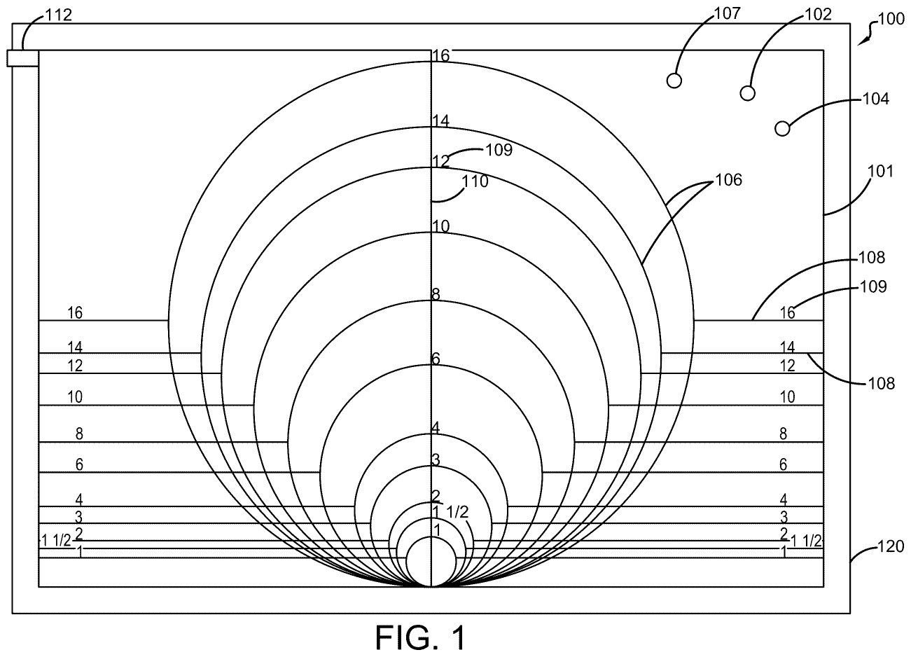

Referring initially to the drawings, FIG. 1 illustrates a top view of one potential embodiment of an eccentric reducer calculator device 100 of the present invention in accordance with the disclosed architecture. The device 100 is designed to provide a precise, portable, and user-friendly tool for determining the exact centerline of piping components, with particular applicability to eccentric reducers used in pipefitting, welding, and fabrication operations. The device 100 may be utilized to accurately align and mark pipe sections, thereby reducing the risk of misalignment during installation. More specifically, the device enables workers to establish correct pipe positioning quickly and with minimal calculation. As a result, the device is particularly beneficial in industrial, commercial, or field environments where accuracy, speed, and repeatability are critical, thereby saving time, reducing rework, and improving overall fabrication efficiency.

The device 100 is comprised of a planar sheet body 101 having a length of approximately 18 inches and a width of approximately 24 inches. Alternative embodiments may be produced in various lengths and widths such as but not limited to 12 by 18 inches, 24 by 36 inches, 30 by 42 inches, or custom dimensions tailored to specific work environments or storage requirements. The planar sheet body 101 may have a rectangular, square, or custom polygonal shape in different embodiments.

The planar sheet body 101 may be manufactured from materials such as but not limited to any combination of heavy-weight paper, laminated cardstock, thin plastic sheet, flexible polymer film, reinforced fiber-reinforced plastic (FRP), or woven synthetic fabric. In one variation, the planar sheet body 101 may be translucent or transparent to allow alignment over printed plans or templates.

Some embodiments of the body 101 may feature a weather-resistant coating 102 (as seen in FIG. 1) such as but not limited to any combination of a polyurethane sealant, silicone-based protective film, UV-resistant varnish, epoxy resin coating, or industrial-grade water-repellent spray. In certain variations, the weather-resistant coating 102 may be combined with a chemical-resistant finish 107 such as but not limited to any combination of fluoropolymer coatings, epoxy-phenolic resin, chlorinated rubber coating, or alkyd-based enamel to withstand solvents, oils, or cutting fluids.

In other embodiments, a lamination 104 may be applied to the planar sheet body 101 to protect against environmental hazards such as but not limited to moisture, oil, welding sparks, abrasive dust, and general workshop debris. The lamination 104 may be comprised of any combination of a clear polyester film, polycarbonate overlay, or heat-sealed vinyl layer.

Centrally located on the planar sheet body 101 may be a plurality of concentric circle markings 106, as seen in FIG. 1, each preferably of progressively increasing diameter. The diameters may correspond to standard pipe outer diameters for use in pipefitting and fabrication tasks, including both metric and/or imperial sizing systems such as but not limited to 1, 1.5, 2, 3, 4, 6, 8, 10, 12, 14, and 16 inches, or equivalent metric conversions. In alternative configurations, the plurality of concentric circle markings 106 may also include non-standard diameters for specialized piping, tubing, or conduit used in niche applications such as HVAC ducting, hydraulic lines, or high-pressure chemical pipelines.

Extending from the central axis of the plurality of concentric circle markings 106 may be a set of horizontal centerline markings 108, as seen in FIG. 1, each extending toward and terminating at opposite edges of the planar sheet body 101. The horizontal centerline markings 108 may serve as alignment references when positioning eccentric reducers, pipe sections, or other cylindrical workpieces on the planar sheet body 101. In some variations, the horizontal centerline markings 108 may also be comprised of numerical labels 109 denoting distance from the center, and/or the diameter of each marking 106. The same labels 109 may also be present near the vertical centerline markings 110.

In certain embodiments, the planar sheet body 101 may further comprise vertical centerline markings 110 to indicate the center of each circle marking 106, as seen in FIG. 1. Each vertical centerline marking 110 may be aligned perpendicular to the horizontal centerline markings 108 to provide a complete orthogonal alignment system. In one variation, each vertical centerline marking 110 may be color-coded to indicate characteristics such as but not limited to material type (e.g., steel, copper, PVC) or pressure class rating (e.g., Schedule 40, Schedule 80), aiding rapid identification during fabrication.

In alternative embodiments, the planar sheet body 101 may be manufactured as a rigid panel from materials such as but not limited to acrylic, aluminum composite, high-density polyethylene (HDPE), or magnetic steel. In this embodiment, the body 101 may be comprised of fasteners 112 such as but not limited to any combination of integrated magnets, edge-mounted clamps, suction cups, or threaded inserts for bolted attachment to welding tables, pipe stands, or other work surfaces.

In one embodiment, the body 101 may have a non-slip bottom surface 120 (as seen in FIG. 1) made from materials such as but not limited to silicone rubber, thermoplastic elastomer (TPE), nitrile rubber, neoprene, or textured polyurethane. The non-slip bottom surface 120 may be applied as a continuous sheet, as a patterned grip layer with raised texture, or as non-slip pads positioned at strategic points on the underside of the body 101. This configuration may prevent shifting of the device 100 during use, particularly on smooth metal surfaces or sloped work areas, thereby improving measurement precision and safety during alignment procedures.

Functionally, the device 100 serves as an eccentric reducer calculator by enabling users to determine the exact center of an eccentric reducer when installing piping. This precision allows installers to establish the correct pipe centerline quickly and without repeated adjustments. The design maximizes accuracy during the fabrication process, thereby reducing the need for rework and ensuring that alignments are correct on the first attempt. This operational efficiency saves considerable time and effort for welders and fitters, particularly in large-scale industrial or field installations. The inclusion of progressively sized concentric circles 106 in conjunction with the horizontal and vertical centerline markings 108 and 110 allows workers to position the planar sheet body 101 on a work surface and instantly reference the next pipe centerline, eliminating guesswork.

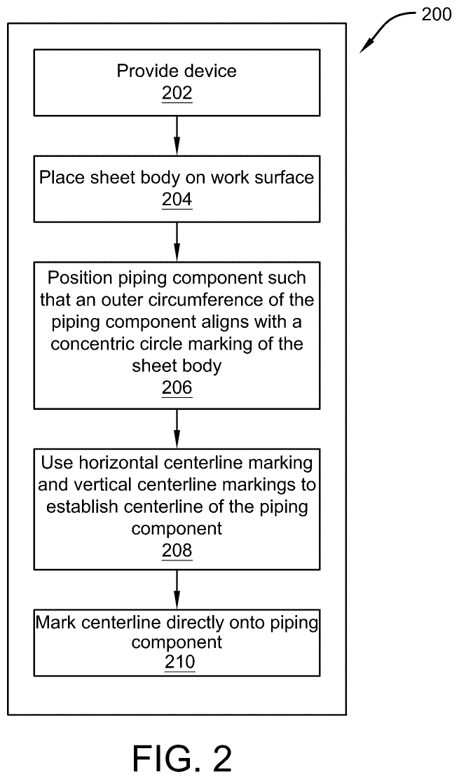

The present invention is also comprised of a method of using 200 the device 100, as seen in FIG. 2. First, a planar sheet body 101 is provided having a plurality of concentric circle markings 106, horizontal centerline markings 108, and vertical centerline markings 110 [Step 202]. Then, the planar sheet body 101 is placed on a work surface using the non-slip bottom surface 120 or fasteners 112 (if present) engaged to prevent movement [Step 204]. Next, a piping component such as an eccentric reducer is positioned so that the outer circumference of the piping component aligns with the corresponding concentric circle marking 106 [Step 206]. The horizontal centerline markings 108 and vertical centerline markings 110 are further be used to establish the exact centerline of the piping component [Step 208]. Finally, the established centerline is marked directly onto the piping component to guide cutting, welding, or installation operations [Step 210].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “eccentric reducer calculator device” and “device” are interchangeable and refer to the eccentric reducer calculator device 100 of the present invention.

Notwithstanding the foregoing, the eccentric reducer calculator device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the eccentric reducer calculator device 100 as shown in the FIGS. are for illustrative purposes only, and that many other sizes and shapes of the eccentric reducer calculator device 100 are well within the scope of the present disclosure. Although the dimensions of the eccentric reducer calculator device 100 are important design parameters for user convenience, the eccentric reducer calculator device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An eccentric reducer calculator device comprising:
a planar sheet body having a plurality of concentric circle markings; and
a plurality of horizontal centerline markings extending from a central axis of the plurality of concentric circle markings toward opposite edges of the planar sheet body.

2. The eccentric reducer calculator device of claim 1, wherein the planar sheet body is comprised of a transparent or translucent material.

3. The eccentric reducer calculator device of claim 1, wherein the planar sheet body is comprised of a weather-resistant coating.

4. The eccentric reducer calculator device of claim 1, wherein the planar sheet body is comprised of a chemical-resistant finish.

5. The eccentric reducer calculator device of claim 1, wherein the planar sheet body is comprised of a lamination.

6. The eccentric reducer calculator device of claim 1, wherein the plurality of horizontal centerline markings are comprised of a plurality of numerical labels.

7. The eccentric reducer calculator device of claim 6, wherein the plurality of numerical labels correspond to a plurality of diameters of the plurality of concentric circle markings.

8. The eccentric reducer calculator device of claim 1, wherein the planar sheet body is comprised of a non-slip bottom surface.

9. The eccentric reducer calculator device of claim 1, wherein the planar sheet body is comprised of a fastener.

10. The eccentric reducer calculator device of claim 9, wherein the fastener is comprised of a magnet, a clamp, a suction cup, or a threaded insert.

11. An eccentric reducer calculator device comprising:
a planar sheet body having a plurality of concentric circle markings;
a plurality of horizontal centerline markings extending from a central axis of the plurality of concentric circle markings toward opposite edges of the planar sheet body; and
a plurality of vertical centerline markings aligned perpendicular to the plurality of horizontal centerline markings.

12. The eccentric reducer calculator device of claim 11, wherein a first vertical centerline marking of the plurality of vertical centerline markings is comprised of a first color and a second vertical centerline marking of the plurality of vertical centerline markings is comprised of a second color.

13. The eccentric reducer calculator device of claim 12, wherein the first color corresponds to a first diameter of a first concentric circle marking of the plurality of concentric circle markings.

14. The eccentric reducer calculator device of claim 13, wherein the second color corresponds to a second diameter of a second concentric circle marking of the plurality of concentric circle markings.

15. The eccentric reducer calculator device of claim 11, wherein the planar sheet body is comprised of a transparent or translucent material.

16. The eccentric reducer calculator device of claim 11, wherein the planar sheet body is comprised of a weather-resistant coating or a chemical-resistant finish.

17. The eccentric reducer calculator device of claim 11, wherein the planar sheet body is comprised of a lamination.

18. The eccentric reducer calculator device of claim 11, wherein the plurality of horizontal centerline markings are comprised of a plurality of numerical labels.

19. The eccentric reducer calculator device of claim 11, wherein the planar sheet body is comprised of a non-slip bottom surface.

20. A method of using an eccentric reducer calculator device, the method comprising the following steps:
providing an eccentric reducer calculator device comprised of a planar sheet body having a plurality of concentric circle markings and a plurality of horizontal centerline markings extending from a central axis of the plurality of concentric circle markings toward a pair of opposite edges of the planar sheet body;
positioning a piping component so that an outer circumference of the piping component aligns with a concentric circle marking of the plurality of concentric circle markings; and
using a horizontal centerline marking of the plurality of horizontal centerline markings to establish a centerline of the piping component.
